(19) United States
(12) Patent Application Publication
(10) Pub. No.: US 2008/0061272 A1
(43) Pub. Date: Mar. 13, 2008

(54) Composition Comprising Trans 1,2-Dichloroethylene

(75) Inventors: Laurent Caron, Sainte Foy Les Lyon (FR); Jean-Pierre Lallier, Saint Bonnet de Mure (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Puteaux (FR)

(21) Appl. No.: 10/593,943

(22) PCT Filed: Mar. 11, 2005
(86) PCT No.: PCT/FR05/00582

§ 371 Date: Oct. 6, 2006

(30) Foreign Application Priority Data
Apr. 6, 2004 (FR) 0403590

(51) Int. Cl. C09K 3/00

(52) U.S. Cl. 252/364; 252/182.12

(57) ABSTRACT

The present invention relates to a composition based on trans-1,2-dichloroethylene. A more particular subject-matter of the invention is a nonflammable composition comprising trans-1,2-dichloroethylene and pentafluoropropane and its use.

The present invention relates to a composition based on trans-1,2-dichloroethylene. A more particular subject-matter of the invention is a non-flammable (absence of flash point) composition comprising trans-1,2-dichloroethylene and pentafluoropropane and its use.

trans-1,2-Dichloroethylene is a chlorinated solvent with a boiling point of 48° C. which, in the same way as trichloroethane, trichloroethylene and perchloroethylene, has a good solubilizing power, in particular for fatty substances (lubricants, oils, fats). Its use has to date been relatively limited because of the existence of a flash point for this solvent. trans-1,2-Dichloroethylene in fact has a flash point of between −11° C. and −4° C. under standard determination conditions (ASTM Standard D3828: closed cup, Setaflash).

U.S. Pat. No. 3,349,039 discloses compositions based on trans-1,2-dichloroethylene and on 1,1,2-trifluoro-1,2,2-trichloroethane or on methylene chloride, the latter two compounds making it possible to eliminate the flash point of trans-1,2-dichloroethylene. However, these mixtures are scarcely of interest now as 1,1,2-trifluoro-1,2,2-trichloroethane has been banned since the Montreal protocol and methylene chloride has been strictly regulated (Carcinogenic, Mutagenic and Reprotoxic harmful substance).

U.S. Pat. No. 6,100,229 discloses compositions based on azeotropic trans-1,2-dichloroethylene and 1,1,1,3,3-pentafluoropropane mixtures but with a high content of 1,1,1,3,3-pentafluoropropane. The trans-1,2-dichloroethylene content is thus reduced to less than 20% and thus the solubilizing power is thereby reduced in proportion due to the nonpolar nature of 1,1,1,3,3-pentafluoropropane. Another disadvantage is the relatively low boiling point of such a mixture, with a value in the region of 20° C. for a composition comprising only 20% of trans-1,2-dichloroethylene.

Patent Application WO 03/078539 relates to a composition comprising 1,1,1,3,3-pentafluoropropane (245fa) and trans-1,2-dichloroethylene, the boiling point of which does not vary by much with the trans-1,2-dichloroethylene content. This document relates to binary compositions (245fa and trans-1,2-dichloroethylene) having a trans-1,2-dichloroethylene content at most of approximately 60% by weight.

Specifically, the document WO 03/078539 specifies that the variation in boiling point observed is approximately 1 degree per 10% by weight of trans-1,2-dichloroethylene and that, preferably, this variation is approximately 0.75 degree or better still approximately 0.6 degree per 10% by weight of trans-1,2-dichloroethylene.

The Applicant Company has developed a composition based on trans-1,2-dichloroethylene which has the advantage of having a good solubilizing power and of not exhibiting a flash point under standard determination conditions (ASTM Standard D 3828).

A subject-matter of the present invention is thus a composition comprising x % by weight of trans-1,2-dichloroethylene, with 80<x<99, and y % by weight of 1,1,1,3,3-pentafluoropropane, with 1<y<20, and which does not exhibit a flash point under standard determination conditions (ASTM Standard D 3828).

Preferably, the composition according to the invention does not have a flash point in the temperature range of use.

The composition according to the invention preferably comprises from 90 to 98% by weight of trans-1,2-dichloroethylene and from 2 to 10% by weight of 1,1,1,3,3-pentafluoropropane.

Advantageously, the composition according to the invention comprises from 95 to 98% by weight of trans-1,2-dichloroethylene and from 2 to 5% by weight of 1,1,1,3,3-pentafluoropropane.

The composition according to the present invention can be used as solvent.

Another subject-matter of the present invention relates to a solvent comprising x % by weight of trans-1,2-dichloroethylene, with 80<x<99, and y % by weight of 1,1,1,3,3-pentafluoropropane, with 1<y<20, and which does not exhibit a flash point under standard determination conditions (ASTM Standard D 3828).

The solvent preferably comprises from 90 to 98% by weight of trans-1,2-dichloroethylene and from 2 to 10% by weight of 1,1,1,3,3-pentafluoropropane.

Advantageously, the solvent according to the invention comprises from 95 to 98% by weight of trans-1,2-dichloroethylene and from 2 to 5% by weight of 1,1,1,3,3-pentafluoropropane.

Advantageously, the composition and/or the solvent according to the present invention does not comprise 1,1,1,3,3-pentafluorobutane (365mfc).

In addition to the nonflammability (absence of flash point) and the solubilizing power, in particular for oils, lubricants and resins, the composition according to the present invention has a boiling point of greater than ambient temperature (22° C.).

The various applications of the composition according to the present invention are in particular the treatment of solid surfaces, such as, for example, the cleaning, degreasing or drying of solid surfaces and the defluxing of printed circuits, the dry cleaning of textiles or the cleaning of refrigerating plants.

The composition according to the present invention can also be used as expanding agent for foams formed from thermosetting polymers, for example polyurethane, as liquid coolants, as agents for depositing silicones and/or as aerosol propellants.

In addition, the composition according to the present invention can be used in a process for the treatment of solid surfaces carried out in an apparatus comprising at least one cleaning tank equipped with a system for cooling vapours (condensation coil) capable of easily trapping the vapours of 1,1,1,3,3-pentafluoropropane, which boils at 15° C.

The composition according to the present invention is advantageously chosen for the cleaning applications (hard surfaces, textiles, refrigerating plants, and the like), applications for which a good solubilizing power is necessary.

### EXPERIMENTAL PART

### Examples 1-3

Three compositions according to the present invention are prepared (Examples 1-3) and then the flash point is determined under standard conditions (ASTM D 3828).

Examples C1 and C2 correspond to compositions not in accordance with the present invention.

The results are given in the table below.

| | trans-1,2- | 1,1,1,3,3- | |
|---|---|---|---|
| | Dichloroethylene | Pentafluoropropane | Flash Point |
| Example | (% by weight) | (% by weight) | ASTM D 3828 |
| C1 | 100% | 0% | −11° C. to −4° C. |
| C2 | 99% | 1% | −11° C. to −8° C. |
| 1 | 98% | 2% | No flash point |
| 2 | 95% | 5% | No flash point |
| 3 | 85% | 15% | No flash point |

### Example 4

A composition comprising 19% of 1,1,1,3,3-pentafluoropropane and 81% of trans-1,2-dichloroethylene is allowed to evaporate at ambient temperature (22° C.) and atmospheric pressure. The composition over time is subsequently determined using gas chromatography. After 13 hours, the level of 1,1,1,3,3-pentafluoropropane in the composition remains sufficiently high and greater than 2%. This composition thus remains nonflammable over time.

The same test is repeated with a composition comprising 5% of 1,1,1,3,3-pentafluoropropane and 95% of trans-1,2-dichloroethylene. After 8 hours, the level of 1,1,1,3,3-pentafluoropropane in the composition remains sufficiently high and greater than 2%. This composition thus remains non-flammable (no flash point is observed) over time.

### Examples 5-7

Test to determine the solubilizing power of the various compositions.

Several compositions (2, 5 and 10% by weight of 245fa and the remainder to 100% by weight being trans-1,2-dichloroethylene) according to the present invention are prepared in flasks cooled to −7° C. to limit the evaporation of the 1,1,1,3,3-pentafluoropropane.

10 ml of each composition are subsequently poured, using a graduated measuring cylinder cooled beforehand to 5° C., into a test tube equipped with a screw top cooled beforehand to 5° C. The amount of whole oil necessary to obtain the desired percentage of oil by volume is then added to the test tube using a propipette; the contents of the test tube are agitated for 30 s and are left standing at ambient temperature. After one hour, the appearance or nonappearance of separate oil/solvent phases is recorded.

Examples C3 and C4 correspond to two compositions not in accordance with the present invention.

The results of the test of the solubilizing power are listed in the table below.

| | Example | | | | |
|---|---|---|---|---|---|
| | 5 | 6 | 7 | C3 | C4 |
| % by weight of | 2% | 5% | 10% | 50% | 80% |
| 245fa | | | | | |
| % of oil by | | | | | |
| volume | | | | | |
| 1% | | | | | NS |
| 9% | S | S | S | | NS |
| 16% | S | S | S | | |
| 33% | S | S | S | NS | |
| 50% | S | S | S | | |
| 60% | S | S | S | | |

S: a single phase
NS: appearance of separate phases

### The % of oil by volume is defined as being the ratio volume of oil×100/total volume

Whole oil: Shell, Macron 1665 S 32 (multiple spindle cutting oil)

1. Composition comprising x % by weight of trans-1,2-dichloroethylene, with 80<x<99, and y % by weight of 1,1,1,3,3-pentafluoropropane, with 1<y<20, and which does not exhibit a flash point under standard determination conditions (ASTM Standard D 3828).

2. Composition according to claim 1, comprising from 90 to 98% by weight of trans-1,2-dichloroethylene and from 2 to 10% by weight of 1,1,1,3,3-pentafluoropropane.

3. Composition according to claim 1 or 2, comprising from 95 to 98% by weight of trans-1,2-dichloroethylene and from 2 to 5% by weight of 1,1,1,3,3-pentafluoropropane.

4. Solvent, characterized in that it is composed of a composition according to any one of the preceding claims.

5. Expanding agent characterised in that it is composed of composition according to claims 1 to 4.
